(19) United States
(12) Patent Application Publication
(10) Pub. No.: US 2016/0047716 A1
(43) Pub. Date: Feb. 18, 2016

(54) METHOD, COMPUTER PROGRAM PRODUCT & SYSTEM

(71) Applicant: AKTIEBOLAGET SKF, Göteborg (SE)

(72) Inventor: Allan THOMSON, Lanark (GB)

(73) Assignee: Aktiebolaget SKF, Göteborg (SE)

(21) Appl. No.: 14/781,932

(22) PCT Filed: Apr. 5, 2013
(86) PCT No.: PCT/EP2013/057176

§ 371 Date: Oct. 2, 2015

(51) Int. Cl. G01M 13/04; G01N 29/46; G01N 29/44; G01N 29/14

(52) U.S. Cl. CPC G01M 13/045; G01N 29/14; G01N 29/46; G01N 29/449

(57) ABSTRACT

A method for processing data obtained from a condition monitoring system, wherein the method comprises a step of obtaining dynamic signal data in a form of a first time waveform including a number of samples from at least one sensor. The method comprises a step of creating a plurality of new time waveforms from the first time waveform, each of the plurality of new time waveforms having a smaller number of samples than the first time waveform, and at least one of transmitting, displaying or storing the plurality of new time waveforms instead of the dynamic signal time waveform data.

### CROSS REFERENCE TO RELATED APPLICATION

This is a United States National Stage Application claiming the benefit of International Application Number PCT/EP2013/057176 filed on 5 Apr. 2013 (May 4, 2013), which is incorporated herein by reference in its entirety.

### TECHNICAL FIELD

The present invention concerns a method, system and computer program product for processing data obtained from a condition monitoring system, such a condition monitoring system for predicting the residual life of a component, such as a bearing, i.e. for predicting when it is necessary or desirable to service, replace or refurbish (re-manufacture) the component.

### BACKGROUND OF THE INVENTION

Condition monitoring is the process of determining the condition of machinery while in operation. Condition monitoring enables the repair of problem components prior to failure and not only helps plant personnel reduce the possibility of catastrophic failure, but also allows them to order parts in advance, schedule manpower, and plan other repairs during downtime.

Components such as rolling-element bearings are often used in critical applications, wherein their failure in service would result in significant commercial loss to the end-user. It is therefore important to be able to predict the residual life of such a bearing, in order to plan intervention in a way that avoids failure in service, while minimizing the losses that may arise from taking the machinery in question out of service to replace the bearing.

The residual life of a rolling-element bearing is generally determined by fatigue of the operating surfaces as a result of repeated stresses in operational use. Fatigue failure of a rolling element bearing results from progressive flaking or pitting of the surfaces of the rolling elements and of the surfaces of the corresponding bearing races. The flaking and pitting may cause seizure of one or more of the rolling elements, which in turn may generate excessive heat, pressure and friction.

Bearings are selected for a specific application on the basis of a calculated or predicted residual life expectancy compatible with the expected type of service in the application in which they will be used. However, this type of life prediction is considered inadequate for the purpose of maintenance planning for several reasons.

One reason is that the actual operation conditions may be quite different from the nominal conditions. Another reason is that a bearing's residual life may be radically compromised by short-duration events or unplanned events, such as overloads, lubrication failures, installation errors, etc. Yet another reason is that, even if nominal operating conditions are accurately reproduced in service, the inherently random character of the fatigue process may give rise to large statistical variations in the actual residual life of substantially identical bearings.

In order to improve maintenance planning, it is common practice to monitor the values of physical quantities related to vibrations and temperature to which a component, such as a bearing, is subjected in operational use, so as to be able to detect the first signs of impending failure.

In a condition monitoring system data dynamic signal data is obtained in the form of a time waveform (i.e. a graph of a varying quantity against time which usually consists of many samples) from at least one sensor. These time waveforms are usually transmitted and displayed to an analyst. This can however result in long transmission and display times and the data can be difficult to display or interpret. The transmission, display, storage and interpretation of such data can require a significant amount of energy, time and expertise, and consequently decreases the rate at which measurements and analyses can be made.

There are condition monitoring systems using vibration level sensors in which only the “overall amplitudes” (i.e. the total amount of vibration occurring in a selected frequency range) of a particular signal are transmitted or displayed. However, such transmitted or displayed data has limited value since it provides no information about the nature of a signal. Additionally, no further information can be post-processed from the transmitted or displayed overall amplitude values.

### SUMMARY OF THE INVENTION

An object of the invention is to provide an improved method for processing data obtained from a condition monitoring system.

This object is achieved by a method comprising the steps of obtaining dynamic signal data in the form of a first time waveform comprising a number of samples from at least one sensor, creating a plurality of new time waveforms from the first time waveform, each of the plurality of new time waveforms having a smaller number of samples than the first time waveform, and transmitting, displaying and/or storing the plurality of new time waveforms instead of the dynamic signal time waveform data.

Such a statistical demodulation method avoids the need to transmit and/or display and/or store the whole first time waveform data from dynamic signals, i.e. a single large data set, by transmitting and/or displaying and/or storing a plurality of new time waveforms having a smaller number of samples than the first time waveform, i.e. a few smaller data sets. The method thereby reduces the amount of data that needs to be transmitted, displayed and/or stored. Transmission, display and data processing times will therefore be shorter, less energy will be required for transmission, display and processing, and memory storage requirements will be substantially lower (1/879 for example), which consequently results in extending the sensor battery life, or reducing the sensor battery size or power generation requirement.

A user will consequently be more quickly warned of deterioration in the condition of a component being monitored and poor installation or poor operating practices, such as misalignment, imbalance, high vibration, lack of lubrication and contamination in the lubricant, etc., which would reduce the residual life of the component if left uncorrected, will be more quickly identified.

The combination of the plurality of new time waveforms, even though their total size is significantly smaller than that of the first time waveform, provides the necessary detail for analysis and assessment of the condition of a component in the time or frequency domain.

Many time waveforms of dynamic signals acquired by condition monitoring systems from slowly rotating components, such as bearings, need to have significantly large time spans whilst maintaining an adequate sample rate so as not to lose detail or events. The number of samples can therefore be very large (often exceeding millions). The statistical demodulation method according to the present invention can significantly reduce the amount of data to a few manageable data sets with respect to storage memory, transmission time and energy, communication and display times in such cases whilst maintaining the necessary detail from the original dynamic signal required for post-processing, analysis and assessment.

According to an embodiment of the invention the first time waveform has a time span and each of the plurality of new time waveforms has the same time span as the first time waveform.

According to an embodiment of the invention the method is carried out once the whole of the first time waveform has been acquired (which requires more memory). Alternatively, the method is carried out continuously; for example as sections of the first time waveform are acquired in an FIFO buffer (which requires less memory but a faster processor).

According to another embodiment of the invention the first time waveform comprises a plurality of parameters and each of the plurality of new time waveforms represents one of the parameters from the first time waveform. The parameters may be selected depending on the type of dynamic signal being provided by the at least one sensor and/or the specific application so as to provide the information necessary for the assessment of the at least one component being monitored by the at least one sensor of the condition monitoring system. According to an embodiment of the invention the step of extracting parameters from the first time waveform is carried out using Discrete Wavelet Transform (DWT), Continuous Wavelet Transform (CWT) or another time domain analysis.

According to a further embodiment of the invention the parameters are any of the following: quantitative or statistical parameters, a peak-to-peak amplitude, an RMS amplitude, a statistical value such as a maximum, minimum, mean or median value, Crestfactor, Kurtosis, threshold crossing event counts, periodicity of events values, wavelet- or FFT-derived amplitudes or parameters, such as harmonic activity or sideband activity.

According to an embodiment of the invention the at least one sensor is arranged to obtain data concerning at least one of the following: vibration, vibration enveloping, acoustic emission (AE), acoustic emission enveloping (AEE), load, temperature, rolling contact force/stress, high frequency stress waves, lubricant condition, rolling surface damage, operating speed, load carried, lubrication conditions, humidity, exposure to moisture or ionic fluids, exposure to mechanical shocks, corrosion, fatigue damage, wear.

According to another embodiment of the invention the at least two parameters are transmitted wirelessly over a wireless communication network.

According to another embodiment of the invention the method comprises the step of storing the plurality of new time waveforms electronically in a database.

According to a further embodiment of the invention the condition monitoring system is arranged to monitor at least one bearing, such as a rolling element bearing. The rolling bearing may be any one of a cylindrical roller bearing, a spherical roller bearing, a toroidal roller bearing, a taper roller bearing, a conical roller bearing or a needle roller bearing.

The present invention also concerns a computer program product that comprises a computer program containing computer program code means arranged to cause a computer or a processor to execute the steps of a method according to any of the embodiments of the invention, stored on a computer-readable medium or a carrier wave.

The present invention further concerns a system for processing data obtained from a condition monitoring system comprising at least one sensor arranged to provide dynamic signal data in the form of a first time waveform comprising a number of samples from the at least one sensor. The system comprises a processing unit arranged to create a plurality of new time waveforms from the first time waveform, each of the plurality of new time waveforms having a smaller number of samples than the first time waveform, and transmission means arranged to transmit or display or store the plurality of new time waveforms instead of the dynamic signal time waveform data.

According to an embodiment of the invention the first time waveform has a time span and each of the plurality of new time waveforms has the same time span as the first time waveform.

According to another embodiment of the invention the first time waveform comprises a plurality of parameters and each of the plurality of new time waveforms represents one of the parameters.

According to a further embodiment of the invention the parameters are any of the following: quantitative or statistical parameters, a peak-to-peak amplitude, an RMS amplitude, a statistical value such as a maximum, minimum, mean or median value, Crestfactor, Kurtosis, threshold crossing event counts, periodicity of events values, wavelet- or FFT-derived amplitudes or parameters, such as harmonic activity or sideband activity.

According to an embodiment of the invention the at least one sensor is arranged to obtain data concerning at least one of the following: vibration, vibration enveloping, acoustic emission (AE), acoustic emission enveloping (AEE), load, temperature, rolling contact force/stress, high frequency stress waves, lubricant condition, rolling surface damage, operating speed, load carried, lubrication conditions, humidity, exposure to moisture or ionic fluids, exposure to mechanical shocks, corrosion, fatigue damage, wear.

According to another embodiment of the invention the system comprises transmitting means arranged to transmit the at least two parameters wirelessly over a wireless communication network.

According to another embodiment of the invention it comprises a storing means arranged to electronically store the plurality of new time waveforms in a database. The system may comprise a prediction unit configured to predict the residual life of a component such as a bearing, using the stored data or the new time waveforms.

According to a further embodiment of the invention the condition monitoring system is arranged to monitor at least one bearing, such as a rolling element bearing.

It should be noted that the method, computer program and system according to the present invention may be used to monitor at least one component, such as a bearing during the component's manufacture, after the component's manufacture and before the component's use, during the component's use, during a period when the component is not in use and/or during the transportation of the component. A complete history log of a component may thereby be created. Accordingly, as a result of having residual life data accumulated over the component's life, starting with its very manufacturing all the way up to the present, a more accurate prediction can be made regarding the residual life of an individual component at any point in its life-cycle. An analyst or end user may be notified of relevant facts including the time at which it is advisable to replace or refurbish the component.

The method, system and computer program product according to the present invention may be used to monitor at least one component, such as a bearing, used in automotive, aerospace, railroad, mining, wind, marine, metal producing and other machine applications which require high wear resistance and/or increased fatigue and tensile strength.

### BRIEF DESCRIPTION OF THE DRAWINGS

The present invention will hereinafter be further explained by means of non-limiting examples with reference to the appended figures where;

FIG. 1 shows a system according to an embodiment of the invention;

FIG. 2 is a flow chart showing the steps of a method according to an embodiment of the invention;

FIG. 3 shows a raw Acoustic Emission Enveloping (AEE) data;

FIG. 4 shows an example of statistical demodulation of an AEE time waveform; and

FIG. 5 shows an example of statistical demodulation of an artificial time waveform.

It should be noted that the drawings have not been drawn to scale and that the dimensions of certain features have been exaggerated for the sake of clarity.

Furthermore, any feature of one embodiment of the invention can be combined with any other feature of any other embodiment of the invention as long as there is no conflict.

### DETAILED DESCRIPTION OF EMBODIMENTS

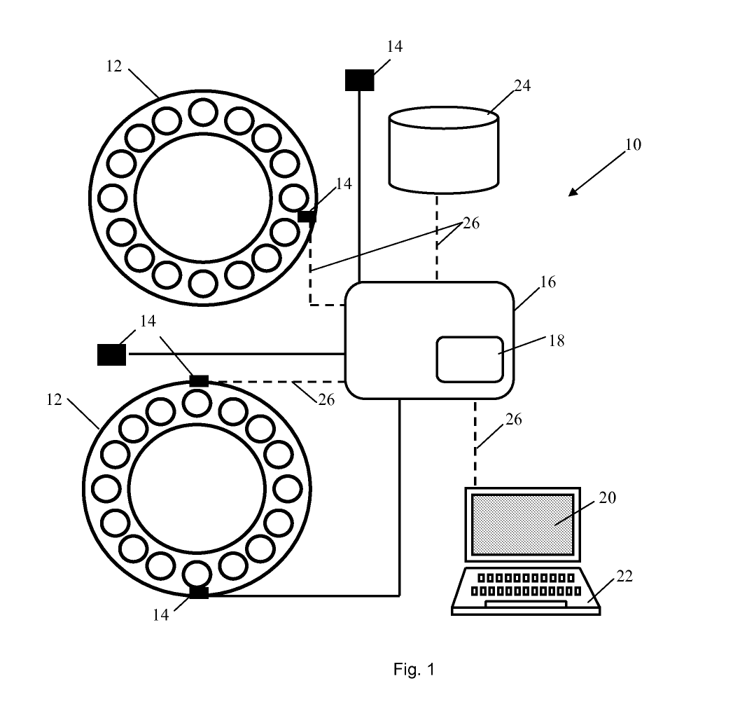

FIG. 1 shows a system 10 for monitoring the condition, and optionally predicting the residual life of a plurality of bearings 12 during their use. The illustrated embodiment shows two rolling element bearings 12, the system 10 according to the present invention may however be used to monitor the condition and optionally predict the residual life of one or more components of any type, and not necessarily all of the same type or size. The system 10 comprises a plurality of sensors 14 configured to obtain dynamic signal data in the form of a first time waveform comprising a number of samples from at least one sensor 14. A sensor 14 may be integrated with a bearing 12, it may be placed in the vicinity of the bearing 12 or remotely from the bearing.

The inner ring and/or outer ring of a bearing 12, which can be monitored using a system or method according to an embodiment of the invention, may be of any size and have any load-carrying capacity. An inner ring and/or an outer ring may for example have a diameter up to a few meters and a load-carrying capacity up to many thousands of tonnes.

The sensors 14 may be configured to obtain data concerning at least one of the following: vibration, temperature, rolling contact force/stress, high frequency stress waves, lubricant condition, rolling surface damage, operating speed, load carried, lubrication conditions, humidity, exposure to moisture or ionic fluids, exposure to mechanical shocks, corrosion, fatigue damage, wear. Data may be obtained periodically, substantially continuously, randomly, on request, or at any suitable time.

Rolling contact forces may for example be recorded by a strain sensor 14 located on an outer surface or side of the bearing's outer ring, or on an inner surface or inner side of the bearing's inner ring. Such a strain sensor 14 could be of the resistance type or use the stretching of an optical fiber embedded within the bearing 12.

A sensor 14 may be embedded in the bearing ring or attached externally to the bearing housing to monitor a lubricant condition. Lubricant can be degraded by contamination in several ways. For example, a lubricant film may fail to protect a bearing 12 against corrosion, either because of its water content or the entrainment of corrosive materials, e.g., acid, salt, etc. As another example, a lubricant film may be contaminated with solid material that has an abrasive effect on the bearing's raceway. A lubrication film can also be compromised by excessive load, low viscosity of the lubricant or contamination of the lubricant with particulate material, or a lack of lubricant. The condition of the lubrication film can be assessed by detecting high-frequency stress waves that propagate through the bearing rings and the surrounding structure in the event of a breakdown of the lubrication film.

The system 10 in the illustrated embodiment comprises a processing unit 16 arranged to create a plurality of new time waveforms from said first time waveform, each of said plurality of new time waveforms having a smaller number of samples than said first time waveform. A transmission unit 18 may be arranged to transmit the plurality of new time waveforms to a display means 20 and/or a device 22 used by a user or analyst and/or a database 24 where the plurality of new time waveforms may be electronically stored. Data may be transmitted to and from the sensors 14, and to and from the processing means 16 in a wired or wireless (26) manner over a wireless communication network.

The database 20 may be maintained by the manufacturer of the bearings 12. The residual life data gathered in the database 20 for a whole batch of bearings 12 enables the manufacturer to extract further information, e.g., about relationships between types or environments of usage versus rates of change of residual life, so as to further improve the service to the end-user.

The system 10 may also comprise a prediction unit (not shown) configured to predict the residual life of each bearing 12 using the stored data in the database 24 and a mathematical residual life predication model.

It should be noted that not all of the components of the system 10 necessarily need to be located in the vicinity of the bearings 12. For example, the database 24 and/or user device 22 may located at a remote location and communicate with at least one data processing unit 16 located in the same or a different place to the bearings 12 by means of a server for example.

It should also be noted that the at least one data processing unit 16, the transmission means 18 and/or the database 24 need not necessarily be separate units but may be combined in any suitable manner. For example a personal computer may be used to carry out a method concerning the present invention.

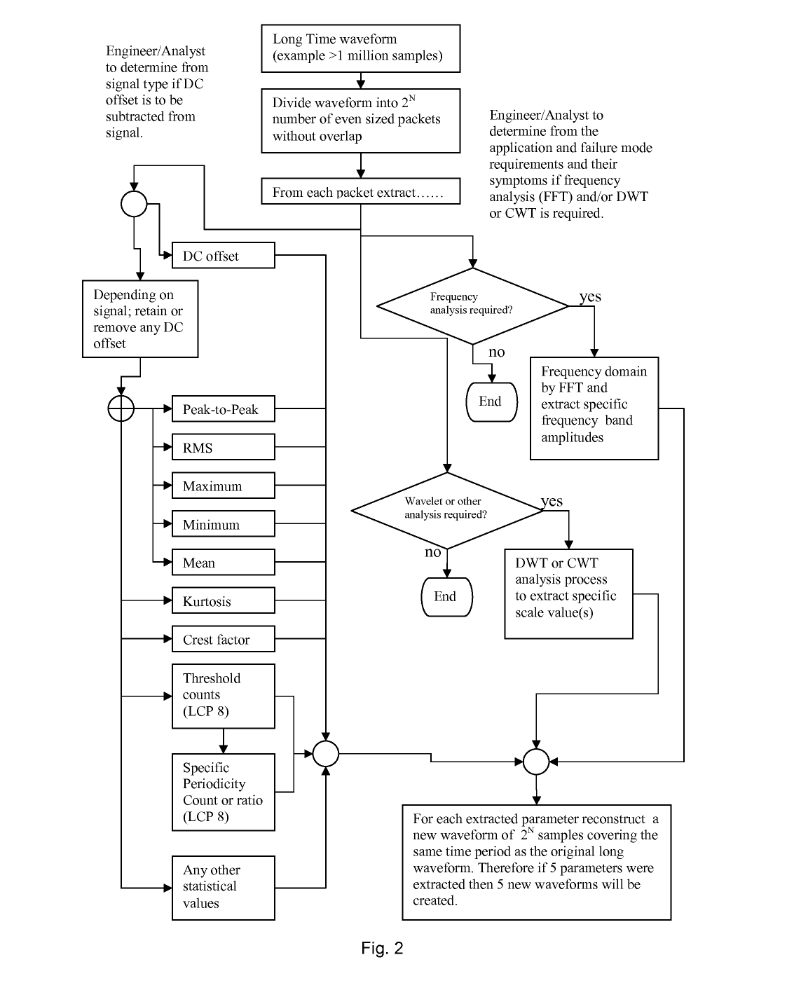

FIG. 2 is a flow chart showing the steps of a method according to an embodiment of the invention. In the method dynamic signal data in the form of a first (long) time waveform comprising over a million samples is obtained from at least one sensor (14). For example the long time waveform may be obtained by monitoring a slowly moving component, such as a slowly rotating bearing and comprise 18 million samples taken over a period of about two hours.

A plurality of evenly sized new time waveforms without overlap, such as 2N new time waveforms, i.e. any number that is 2 to the power of a whole number, for example if N=12 then 212 is 4096) is created from the first time waveform. Each of said plurality of new time waveforms has a smaller number of samples than the first (long) time waveform but the same time span as the first (long) time waveform. An analyst can decide whether it is necessary to retain or remove any DC offset from the time waveform. If necessary, a Fast Fourier Transform (FFT), wavelet analysis or some other required analysis is performed by the sensor 14 or by a processing unit 16.

At least one parameter 29 is extracted from each new time waveform using Discrete Wavelet Transform (DWT), Continuous Wavelet Transform (CWT) or another time domain analysis for example. The extracted parameters 29 may be any of the following: quantitative or statistical parameters 29, a peak-to-peak amplitude, a Root Mean Squared (RMS) amplitude, a statistical value such as a maximum, minimum, mean or median value, Crestfactor, Kurtosis, threshold crossing event counts, periodicity of events values, wavelet- or FFT-derived amplitudes or parameters 29, such as harmonic activity or sideband activity or any other statistical value.

The extracted parameters 29 may be transmitted and/or displayed and/or stored instead of the first (long) time waveform. The parameters 29 may be transmitted wirelessly over a wireless network, in a wired manner, or in a combination of wired and wireless manners. For each extracted parameter a time waveform of 2N samples covering the same time period as the first (long) time waveform may be reconstructed. If five parameters 29 are extracted from the new time waveforms then five new reconstructed time waveforms may be created for example.

The parameters 29 may then be analyzed or processed further to obtain condition status information concerning the at least one component being monitored and/or to understand the nature of the original first (long) time waveform and any defect(s) associated with it and the severity thereof. The parameters 29 and/or the results of the analyses may be stored in a database 24.

The parameters 29 may be used to make a prediction of the residual life of a bearing 12. Once such a prediction has been made, it may be displayed on display means 20, and/or sent to a user device 22, bearing manufacturer, database 20 and/or another prediction unit. Notification of when it is advisable to service, replace or refurbish one or more bearings 12 being monitored by the system 10 may be made in any suitable manner, such as via a communication network, via an e-mail or telephone call, a letter, facsimile, alarm signal, or a visiting representative of the manufacturer.

The condition status or prediction of the residual life of a bearing 12 may be used to inform a user of when he/she should replace the bearing 12. Intervention to replace the bearing 12 is justified, when the cost of intervention (including labor, material and loss of, for example, plant output) is justified by the reduction in the risk cost implicit in continued operation. The risk cost may be calculated as the product of the probability of failure in service on the one hand, and the financial penalty arising from such failure in service, on the other hand.

The method according to the present invention may be carried out at any point within a condition monitoring system 10, such as within a sensor 14 or within a fixed or portable processing unit 16 or at an intermediate or final process/stage.

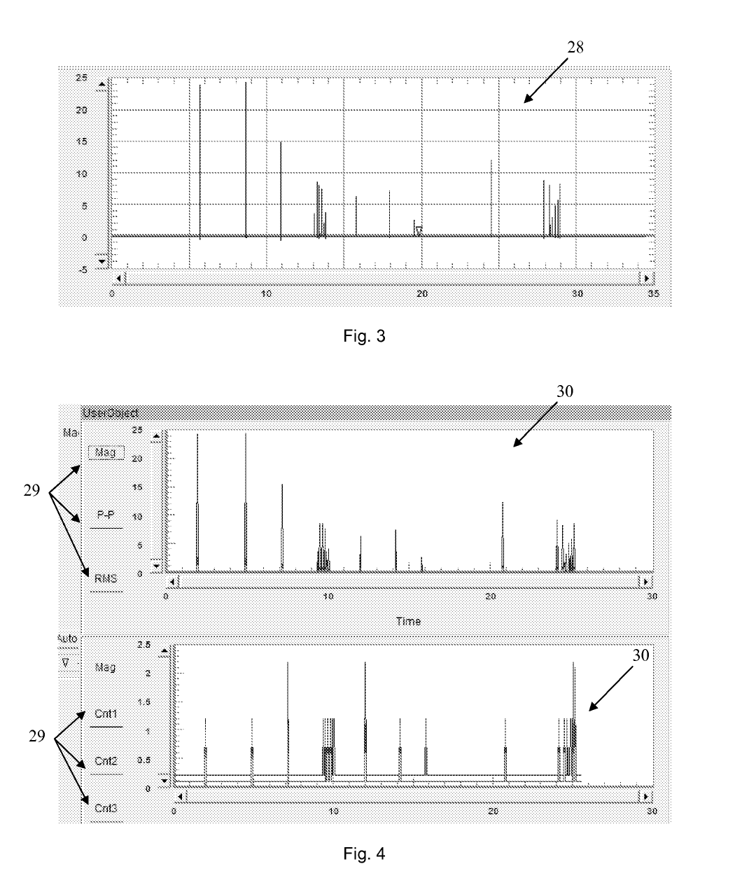

FIG. 3 shows raw Acoustic Emission Enveloping (AEE) data 28 obtained by a sensor 14 of a condition monitoring system according to the present invention. The data was obtained over a 34 second period at 5120 samples/second to capture spike amplitudes resulting in a time waveform of about 176,128 samples (333kB). A five minute acquisition period would require more than 3 MB of memory.

FIG. 4 shows an example of statistical demodulation of an AEE time waveform using a system, method or computer program product according to the present invention. Peak-to-peak, RMS and counts at thresholds of 2, 5 and 12 with a decimation of a factor of 256 (20 samples/second) have been extracted to create five separate new time waveforms 30 of 512 samples each over about 25.6 seconds containing all of the necessary details for analysis. 4096 samples would provide nearly 5 minutes of data with five time waveforms totaling only 65 kB.

The upper plot of FIG. 4 shows two superimposed new time waveforms 30 of peak-to-peak and RMS parameters 29, and the lower plot of FIG. 4 shows three superimposed new time waveforms 30 of counts at thresholds of 2, 5 and 12). The extracted parameters 29 represented in the new time waveforms 30 may be processed further to reveal trends and thereby provide further condition status information concerning the at least one component being monitored and to understand the nature of the original time waveforms from which they were extracted and any defect(s) associated with them and the severity thereof.

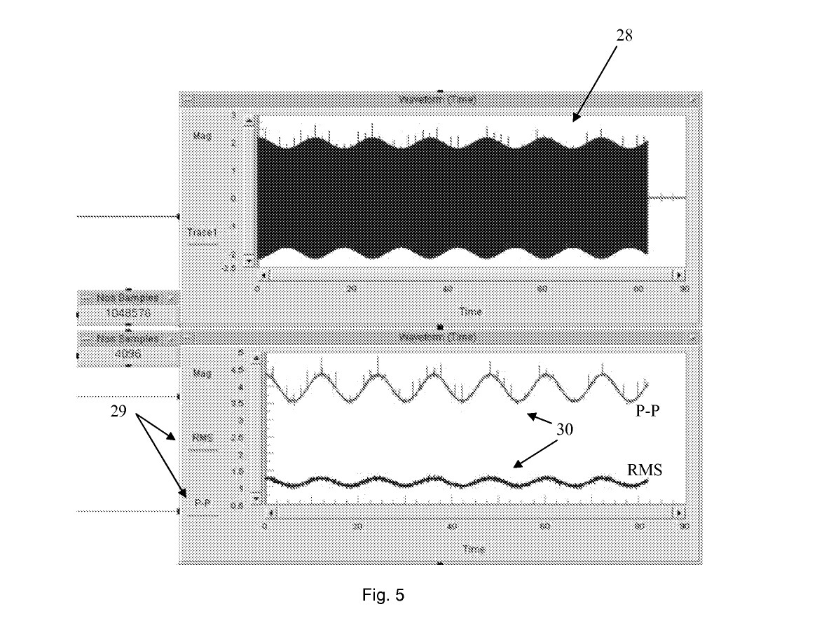

The upper plot of FIG. 5 shows an original artificial time waveform 28 of 1,048,576 samples taken over 82 seconds duration. Each packet size of 256 samples with statistical values extracted from each to form two new time waveforms 30 of 4096 samples covering the same period and representing the RMS (Root Mean Squared value of the samples in the original artificial time waveform 28), and a peak-to-peak amplitude (maximum-minimum values) variation in time is shown in the lower plot of FIG. 5. This results in substantial memory space savings and transmission time and energy savings.

Further modifications of the invention within the scope of the claims would be apparent to a skilled person. Even though the described embodiments are directed to a method, system and computer program product for monitoring at least one component such as a bearing, such a method, system and computer program product may be used for monitoring the status and optionally predicting the residual life of another component of rotating machinery, such as a gear wheel.

1. A method for processing data obtained from a condition monitoring system, the method comprising steps of:
obtaining dynamic signal data in a form of a first time waveform including a number of samples from at least one sensor;
creating a plurality of new time waveforms from the first time waveform, each of the plurality of new time waveforms having a smaller number of samples than the first time waveform, and
at least one of: transmitting, displaying, and storing the plurality of new time waveforms instead of the dynamic signal time waveform data.

2. The method according to claim 1, wherein the first time waveform has a time span and each of the plurality of new time waveforms has the same time span as the first time waveform.

3. The method according to claim 1, wherein the first time waveform comprises a plurality of parameters and each of the plurality of new time waveforms represents one of the parameters.

4. The method according to claim 1, wherein the parameters are any of the following: quantitative parameters, statistical parameters, a peak-to-peak amplitude, an RMS amplitude, a statistical value, a maximum statistical value, a minimum statistical value, a mean statistical value, a Crestfactor, a Kurtosis, threshold crossing event counts, periodicity of events values, wavelet-derived amplitudes, wavelet-derived parameters, FFT-derived amplitudes, FFT-derived parameters, harmonic activity, and sideband activity.

5. The method according to claim 1, characterized in that the at least one sensor is arranged to obtain data concerning at least one of the following: vibration, vibration enveloping, acoustic emission, acoustic emission enveloping, a load, temperature, a rolling contact force, a rolling contact stress, high frequency stress waves, a lubricant condition, rolling surface damage, operating speed, a load carried, lubrication conditions, humidity, exposure to moisture, exposure to ionic fluids, exposure to mechanical shocks, corrosion, fatigue damage, and wear.

6. The method according to claim 1, wherein the at least two parameters are transmitted wirelessly over a wireless communication network.

7. The method according to claim 1, wherein the condition monitoring system is arranged to monitor at least one bearing.

8. A computer program product, comprising a computer program containing computer program code arranged to cause one of a computer or a processor to execute steps of:
obtaining dynamic signal data in a form of a first time waveform including a number of samples from at least one sensor;
creating a plurality of new time waveforms from the first time waveform, each of the plurality of new time waveforms having a smaller number of samples than the first time waveform; and
at least one of: transmitting, displaying, and storing the plurality of new time waveforms instead of the dynamic signal time waveform data,
wherein the computer program is stored on one of: a computer-readable medium or a carrier wave.

9. A system for processing data obtained from a condition monitoring system, the system comprising:
at least one sensor arranged to provide dynamic signal data in a form of a first time waveform having a number of samples from the at least one sensor;
a processing unit arranged to create a plurality of new time waveforms from the first time waveform, each of the plurality of new time waveforms having a smaller number of samples than the first time waveform; and
a transmission system arranged to at least one of transmit, display, and store the plurality of new time waveforms instead of the dynamic signal time waveform data.

10. The system according to claim 9, the first time waveform has a time span and each of the plurality of new time waveforms has the same time span as the first time waveform.

11. The system according to claim 9, wherein the first time waveform comprises a plurality of parameters and each of the plurality of new time waveforms represents one of the parameters.

12. The system according to claim 9, wherein the parameters are any of the following: quantitative or statistical parameters, a peak-to-peak amplitude, an RMS amplitude, a statistical value, a maximum statistical value, a minimum statistical value, a mean statistical value, a median statistical value, a Crestfactor, a Kurtosis, threshold crossing event counts, periodicity of events values, wavelet-derived amplitudes, wavelet-derived parameters, FFT-derived amplitudes, FFT-derived parameters, harmonic activity, and sideband activity.

13. The system according to claim 9, wherein the at least one sensor is arranged to obtain data concerning at least one of the following: vibration, vibration enveloping, acoustic emission, acoustic emission enveloping, a load, a temperature, a rolling contact force, a rolling contact stress, high frequency stress waves, a lubricant condition, rolling surface damage, an operating speed, a load carried, lubrication conditions, humidity, exposure to moisture, exposure to ionic fluids, exposure to mechanical shocks, corrosion, fatigue damage, and wear.

14. The system according to claim 1, a transmitting system means arranged to transmit the at least two parameters wirelessly over a wireless communication network.

15. The system according to claim 9, wherein the condition monitoring system is arranged to monitor at least one bearing.

16. The system according to claim 9, wherein the condition monitoring system is arranged to monitor at least one rolling element bearing.

17. The method according to claim 1, wherein the condition monitoring system is arranged to monitor at least one rolling element bearing.
